(19) United States
(12) Patent Application Publication
(10) Pub. No.: US 2025/0167276 A1
(43) Pub. Date: May 22, 2025

(54) APPARATUS FOR FORMING ELECTRICAL ENERGY STORAGE DEVICES

(71) Applicant: I.M.A. INDUSTRIA MACCHINE AUTOMATICHE S.P.A. UNIPERSONALE, Ozzano dell’Emilia (BO) (IT)

(72) Inventor: Mario SPATAFORA, Granarolo dell’Emilia (BO) (IT)

(21) Appl. No.: 18/837,478

(22) PCT Filed: Feb. 10, 2023
(86) PCT No.: PCT/IT2023/050042

§ 371 Date: Aug. 9, 2024

(30) Foreign Application Priority Data
Feb. 11, 2022 (IT) 102022000002576

(51) Int. Cl. H01M 10/04; H01M 50/536

(52) U.S. Cl. CPC H01M 10/0409; H01M 10/0431; H01M 10/0477; H01M 50/536

(57) ABSTRACT

The apparatus for forming electric energy storage devices, of the type including a cylindrical winding formed by at least one anode element, a cathode element and a separator interposed between said anode and cathode elements, and bearing a pair of metal disks, applied to the opposite ends thereof, adapted to make contact with the terminals of said anode and cathode elements, includes a rotatable member adapted to bring in succession said cylindrical windings at a series of operative stations. The apparatus includes first feeding means adapted to operate the advancement in ordered sequence of said cylindrical windings; means for transferring said cylindrical windings to said rotatable member; second feeding means adapted to operate the feeding to said rotatable member of said pairs of metal disks; and means of welding said pairs of metal disks to said terminals of said anode and cathode elements of the cylindrical windings.

### TECHNICAL FIELD

The present invention relates to an apparatus and a method for forming electrical energy storage devices, such as in particular cylindrical electric batteries.

### PRIOR ART

The use of cylindrical electric batteries consisting of a cylindrical electrode winding, known in the specific field as jelly roll, is currently known in the field of electrical energy storage devices. Such a cylindrical winding comprises in particular an anode element and a cathode element made in the form of flexible strips and separated from each other by a separator. The winding of the electrodes is placed inside a cylindrical container, for example of metallic material.

Respective electrode terminals, known in the specific sector as flags, are protruding from the anode and cathode elements, at the opposite ends of the cylindrical winding.

According to a known embodiment of cylindrical electric batteries, the opposite ends of the cylindrical winding are provided with respective covers, made of metal disks made integral by welding to the terminals of the electrodes of the cylindrical winding.

Such an electric battery is disclosed for example in European patents EP 0 948 066 and EP 2 610 954.

In the formation of said cylindrical electric batteries, a critical phase is the welding of the metal disks at the ends of the cylindrical winding. In order to obtain correct operation, it is necessary to ensure a perfect centering of the metal disks covering the ends of the cylindrical winding with respect to the same cylindrical winding.

In the specified sector, several systems have been proposed for stably associating the metal disks at the ends of the anode and cathode elements of the cylindrical winding, which however do not suit the current production needs of the sector.

CN 214417944U discloses an apparatus for welding the metal disks to the opposite ends of the cylindrical windings comprising a carousel mechanism rotatably carried according to a vertical axis and peripherally surrounded by a feeding device of the cylindrical windings, a feeding device of the metal disks and a welding device, adapted to operate in sequence according to the direction of rotation of the carousel. In operation, a first metal disk is positioned at one end of the cylindrical winding and subsequently welded. The apparatus further comprises a handling device which rotates the cylindrical winding for positioning and welding a second metal disk to the opposite end of the cylindrical winding.

The mentioned solution has a relatively limited operating speed. In addition, the centering of the metal disks on the cylindrical winding is often not sufficiently precise, which causes several problems in forming electric batteries. In particular, in the absence of a precise centering of the metal disks, it is difficult and sometimes impossible to insert the winding inside the relative cylindrical container.

It is also complained that current systems for forming electrical energy storage devices, such as in particular cylindrical electric batteries, often have high complexity, low efficiency and high production costs.

### SUMMARY OF THE INVENTION

The aim of the present invention is to solve the aforementioned problems, by devising an apparatus that allows to optimally form the electrical energy storage devices of the type of cylindrical electric batteries.

Within the scope of this aim, it is a further object of the invention to provide an apparatus for forming cylindrical electric batteries that ensures the perfect centering of the metal disks covering the ends of the cylindrical winding.

Another object of the invention is to provide an apparatus for forming cylindrical electric batteries capable of ensuring high performance.

Yet another object of the invention is to provide an apparatus for forming cylindrical electric batteries which ensures the achievement of a high production speed.

A further object of the invention is to provide an apparatus for forming cylindrical electric batteries of simple constructional and functional conception, which is reliable in operation, versatile, and has relatively inexpensive cost.

The aforementioned aims are achieved, according to the present invention, by the apparatus for forming electric energy storage devices, such as cylindrical electric batteries, comprising a cylindrical winding formed by at least one anode element, a cathode element and a separator element interposed between said anode and cathode elements, and bearing applied to the opposite ends a pair of metal disks able to make contact with the terminals of said anode and cathode elements, according to claim 1.

The apparatus comprises a rotatable member adapted to carry in succession said cylindrical windings at a series of operative stations.

Preferably said rotatable member is operable in rotation according to a horizontal axis of rotation.

The rotatable member peripherally carries, in regularly distributed manner, a series of gripping members of said cylindrical windings to be carried in succession at said operative stations.

Preferably, said gripping members comprise respectively a pair of pliers pivoted according to axes parallel to the axis of rotation of the same rotatable member and adapted to be actuated in angular rotation between a reciprocal open position and a closed position in which the same pliers are adapted to retain a relative cylindrical winding.

The apparatus comprises first feeding means adapted to operate the advancement in orderly sequence of said cylindrical windings and means for transferring said cylindrical windings from said first feeding means to said rotatable member.

Preferably said transfer means comprises a lifting member operable with tilting motion so as to intercept in sequence said cylindrical windings fed by said first feeding means, said lifting member being movable with tilting motion on a plane longitudinal to said first feeding means.

Preferably said transfer means comprises a counter-lift member mounted tilting on the same axis of tilting of said lifting member, so as to retain said cylindrical winding lifted by the same lifting member.

The apparatus comprises second feeding means adapted to feed in orderly sequence said pairs of metal disks to said rotatable member.

According to one aspect of the invention, said second feeding means comprises conveyor means adapted to feed in sequence said pairs of metal disks and a device for collecting a pair of said pairs of metal disks, movable with reciprocating motion in a substantially radial direction to said rotatable member and carrying a pair of suction cup gripping members adapted to receive said pair of metal disks from said conveyor means.

Preferably said conveyor means comprises a pair of screw conveyors configured to advance the pairs of metal disks towards said collection device.

Preferably said second feeding means further comprises a pair of positioning levers, which are provided, in opposite positions, with further gripping members adapted to receive said pair of metal disks from said collection device and to transfer it to centering means of said metal disks.

Preferably said further gripping members are adapted to be driven in axial rotation, according to an axis parallel to the axis of rotation of said rotatable member, by motor members configured to adjust the angular position of said pair of metal disks.

Advantageously said suction cup gripping members associated with said collection device are angularly rotatable, according to a respective axis, between a collecting position facing said conveyor means and an outwardly facing control position, wherein said metal disks carried by said suction cup gripping members pass in front of respective video cameras to control their correct orientation.

Preferably said positioning levers are slidably mounted on a shaft defining the axis of tilting of the same positioning levers, so as to allow their actuation in mutual approaching or distancing movement.

The apparatus comprises means of centering said metal disks and said respective cylindrical windings configured respectively to simultaneously align the disks of each of said pair of metal disks with the terminals of the respective cylindrical winding and to position the axis of the cylindrical winding in a predefined position.

Advantageously said means for centering said cylindrical windings comprises shaped jaws mounted at the end of said pliers and adapted to operate the centering of said cylindrical winding.

Preferably each shaped jaw comprises an element pivoted on the respective pliers and has an arc-shaped circumference profile.

Advantageously, said means for centering said metal disks comprises a pair of alignment elements arranged at each gripping member of said rotatable member and tiltingly carried by the rotatable member itself, said alignment members being movable between a disengagement position, in which they are spread apart from each other, and a working position in which they center said pair of metal disks on the respective cylindrical winding.

Preferably said alignment elements respectively comprise an annular member mounted at the end of an arm tiltingly carried by said rotatable member, each annular member being internally provided with a plurality of centering members configured to engage a respective metal disk of each of said pair of metal disks, so as to perform the precise centering of said cylindrical winding and said pair of metal disks, when they are in the working position.

Preferably there are three of said centering members, spaced 120° apart from one another.

Advantageously, the apparatus provides for at least one control station comprising a pair of cameras arranged coaxially to the axis of the cylindrical winding to be inspected and a pair of contrasting elements adapted to be driven in an axial direction to the same cylindrical winding so as to adhere to the lateral surfaces of said cylindrical winding, to ensure the same focal length at both said cameras.

Preferably at least one said control station is arranged upstream of the station of positioning of said metal disks, according to the direction of rotation of said rotatable member.

Preferably said contrast elements are made of transparent material.

Preferably said contrast elements are carried by respective translating members movable coaxially on command of suitably controlled motor members.

The apparatus comprises means for welding said pairs of metal disks to said terminals of said anode and cathode elements of the cylindrical windings.

Preferably said welding means comprises a pair of laser sources arranged coaxial to the axis of said cylindrical winding.

Advantageously, during the welding step said cylindrical winding is clamped between a further pair of contrasting elements adapted to be actuated in an axial direction to the same cylindrical winding, so as to adhere to said metal disks applied to the lateral surfaces of said cylindrical winding.

The present invention also relates to a method for forming electrical energy storage devices, of the type comprising a cylindrical winding formed by at least one anode element, a cathode element and a separator interposed between said anode and cathode elements, and bearing a pair of metal disks, applied to the opposite ends, which are adapted to make contact with terminals of said anode and cathode elements, comprising the steps of

a. advancing in an orderly sequence a series of said cylindrical windings;

b. orderly transferring said cylindrical windings to a rotatable member adapted to carry in succession the same cylindrical windings to a series of operating stations;

c. feeding, in a suitable phase relationship, said pairs of metal disks to said rotatable member;

d. associating said pairs of metal disks (3) with controlled pressure to the opposite ends of said cylindrical windings;

e. centering said metal disks on said respective cylindrical windings;

f. welding said pairs of metal disks to said terminals of said anode and cathode elements of the cylindrical windings.

Advantageously, the method comprises the further step of

b1. carrying out the control of the correct alignment of the same cylindrical winding, in at least one control station, by means of a pair of cameras arranged coaxially to the axis of the cylindrical winding to be inspected.

### BRIEF DESCRIPTION OF THE DRAWINGS

The details of the invention will become more apparent from the detailed description of a preferred embodiment of the apparatus for forming electrical energy storage devices, such as cylindrical electric batteries, illustrated as examples in the accompanying drawings, in which:

FIG. 1 is a schematic front view of the apparatus for forming cylindrical electric batteries according to the present invention;

FIG. 2 is a side view of said apparatus for forming cylindrical electric batteries;

FIG. 3 is an enlarged front view of means for transferring said cylindrical windings to the rotatable member of the apparatus;

FIGS. 4, 5 and 6 are respectively a detailed view of further details of the apparatus; and

FIGS. 7a, 8a; 7b, 8b; 7c, 8c and 7d, 8d are respectively a front view and a top view of the means for feeding the metal disks to the rotatable member in different operative steps.

### DETAILED DESCRIPTION

With particular reference to these figures, the reference numeral 1 indicates as a whole the apparatus for forming electric energy storage devices, such as in particular electric batteries composed of a cylindrical winding or jelly roll 2 formed by at least one anode element, a cathode element and a separator interposed between said anode and cathode elements; the cylindrical winding 2 bears, applied to the opposite ends thereof, a pair of metal disks 3 able to make contact with respective terminals of said anode and cathode elements. To this end, said anode and cathode elements have, at one end, a terminal section or flag projecting laterally from the cylindrical winding 2.

The apparatus 1 comprises a rotatable member 4 adapted to successively bring said cylindrical windings 2 at a series of operative stations in which the formation of the cylindrical electric batteries is completed, as specified below. The rotatable member 4 is rotatable, according to a horizontal axis of rotation, by motor members, not shown.

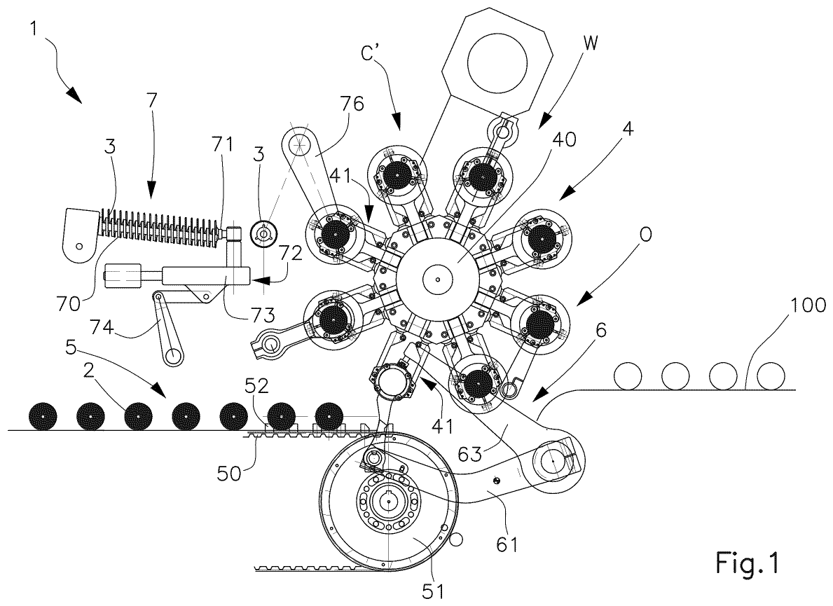

The apparatus 1 comprises first feeding means 5 adapted to operate the advancement in an ordered sequence of said cylindrical windings 2 (see FIG. 1). The first feeding means 5 comprises a conveyor belt 50 that develops on a horizontal feeding plane and consists of a toothed belt that is wound on a plurality of suitably motorized gear wheels 51. The toothed belt 50 has a series of pockets 52 adapted to contain the cylindrical windings 2, suitably spaced from one another and arranged with their axis horizontally transverse to the direction of advancement. The pockets 52 are suitably interchangeable, depending on the dimensions of the cylindrical windings 2.

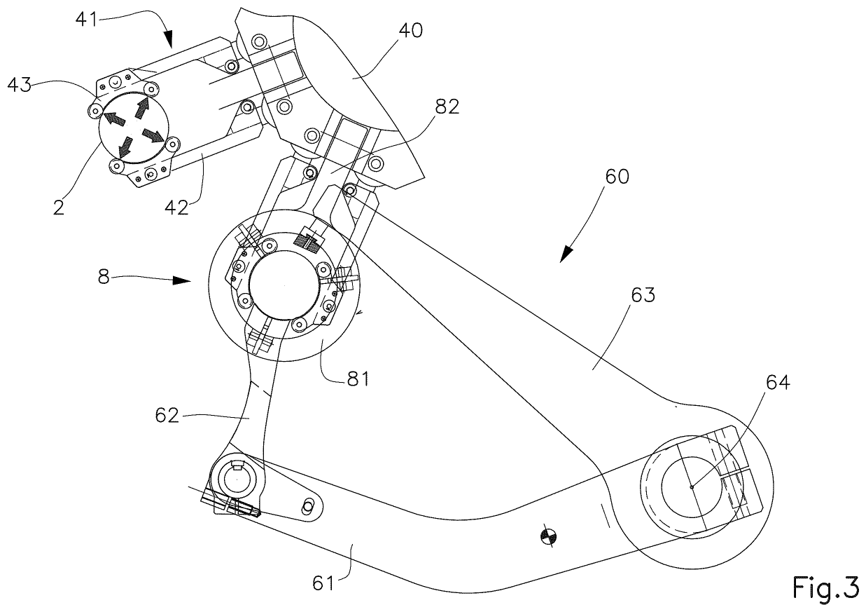

Downstream of the first feeding means 5, transfer means 6 is arranged, adapted to transfer in sequence the cylindrical windings 2 to the rotatable member 4 (see FIG. 3). Said transfer means 6 comprises a lifting member 60 adapted to be operated with tilting motion so as to intercept in sequence the cylindrical windings 2 fed by the first feeding means 5. In particular, the lifting member 60 is movable with tilting motion on a vertical plane longitudinal to the conveyor belt 50.

The lifting member 60 is constituted by a tilting lever 61 having an angled arm 62 applied to the free end to engage the cylindrical winding 2 to be transferred to the rotatable member 4.

A counter-lifting member 63, mounted tilting on the same axis of tilting 64 of the lever 61 of the lifting member 60, is adapted to cooperate with the lifting member 60, so as to retain the cylindrical winding 2 lifted by the same lifting member 60.

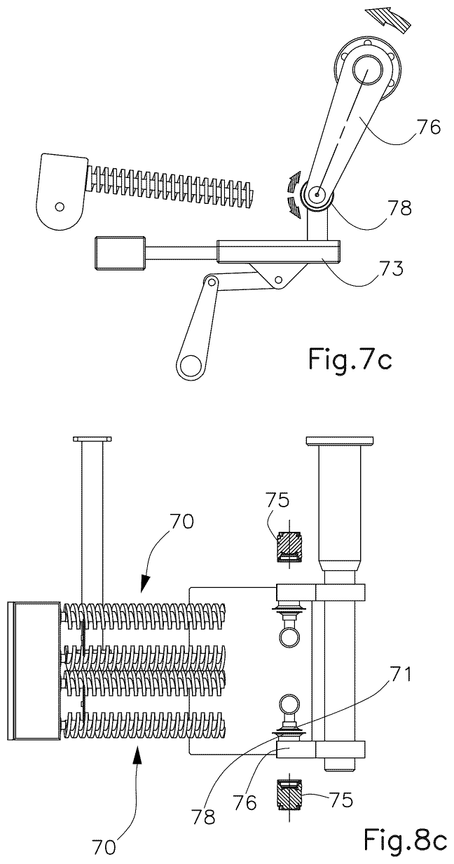

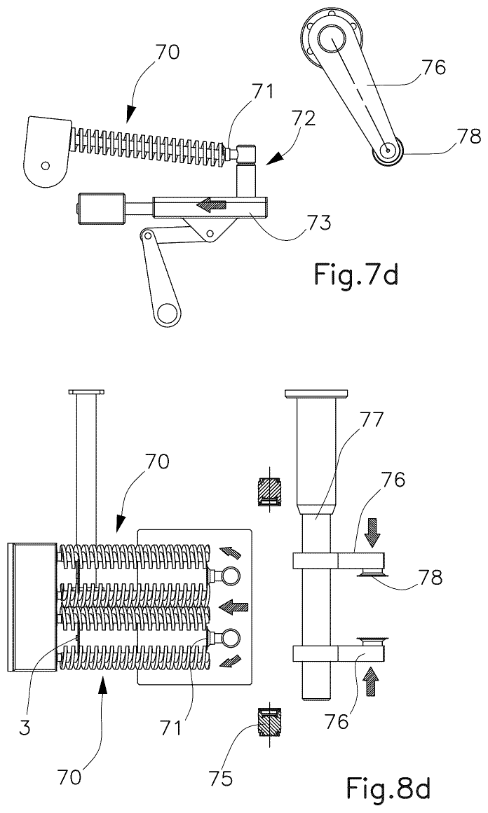

In suitable phase relationship with the feeding of the cylindrical windings 2 to the rotatable member 4, second feeding means 7 supply the metal disks 3 adapted to make contact with the terminals of the anode and cathode elements of the same cylindrical windings 2. Said second feeding means 7 comprises a first and a second pair of screw conveyors 70 between which first and second metal disks 3 covering the cylindrical windings 2 are retained in advancement (see FIGS. 7a, 8a).

Upon exiting the screw conveyors 70, the metal disks 3 are collected from respective suction cup gripping members 71 of a collection device 72. The collection device 72 comprises a carriage 73 with reciprocating motion, movable on command of a special lever 74, in a substantially radial direction to the rotatable member 4.

Preferably the suction cup gripping members 71 are angularly rotatable, according to a respective axis perpendicular to the carriage 73, between a collecting position facing the corresponding screw conveyor 70 and a control position facing the outside of the same carriage 73. In the control position, the metal disks 3 carried by the suction cup gripping members 71 pass in front of respective cameras 75 which control their correct orientation (see FIGS. 7b, 8b).

Downstream of the screw conveyors 70, the metal disks 3 carried by the suction cup gripping members 71 of the collection device 72 are transferred to a pair of positioning levers 76 mounted tilting according to an axis parallel to the axis of the rotatable member 4. The positioning levers 76 are slidably mounted on a shaft 77 that defines the axis of tilting of the same positioning levers 76, so as to allow their actuation in mutual approaching or distancing motion.

The positioning levers 76, in turn, carry, in opposite positions, further gripping members 78 adapted to receive said pair of metal disks 3 from the collection device 72 and to transfer it to centering means 8 of said metal disks 3. Preferably, these additional gripping members 78 are operable in axial rotation, according to an axis parallel to the axis of rotation of said rotatable member 4, by means of drive members configured to adjust the angular position of said pair of metal disks 3.

The rotatable member 4 comprises a wheel 40 which carries peripherally, in regularly distributed manner, a series of pliers gripping members 41.

Each of said gripping members 41 comprises a pair of pliers 42 pivoted according to axes parallel to the axis of rotation of the rotatable member 4 and adapted to be actuated in angular rotation between a reciprocal open position and a closed position, in which the same pliers 42 are adapted to retain a relative cylindrical winding 2.

Preferably the pliers 42 are adapted to be driven in angular rotation by means of special cam means, not shown.

According to one aspect of the invention, the apparatus comprises centering means 8, 43 of the metal disks 3 and of the respective cylindrical windings 2 configured respectively to simultaneously align the disks of each of said pair of metal disks 3 with the terminals of the respective cylindrical winding 2 and to position the axis of the cylindrical winding 2 in a predefined position.

In particular, said centering means 43 of the cylindrical windings 2 comprises shaped jaws 43 mounted at the end of the pliers 42 and adapted to carry out the centering of the cylindrical winding 2 (see FIG. 3).

Advantageously, said means 8 for centering said metal disks comprises a pair of alignment elements 80 arranged at each gripping member 41 of said rotatable member 4 and tiltingly carried by the same rotatable member 4, said alignment members 80 being movable between a disengagement position, in which they are spread apart from each other, and a working position in which they center said pair of metal disks 3 on the respective cylindrical winding 2.

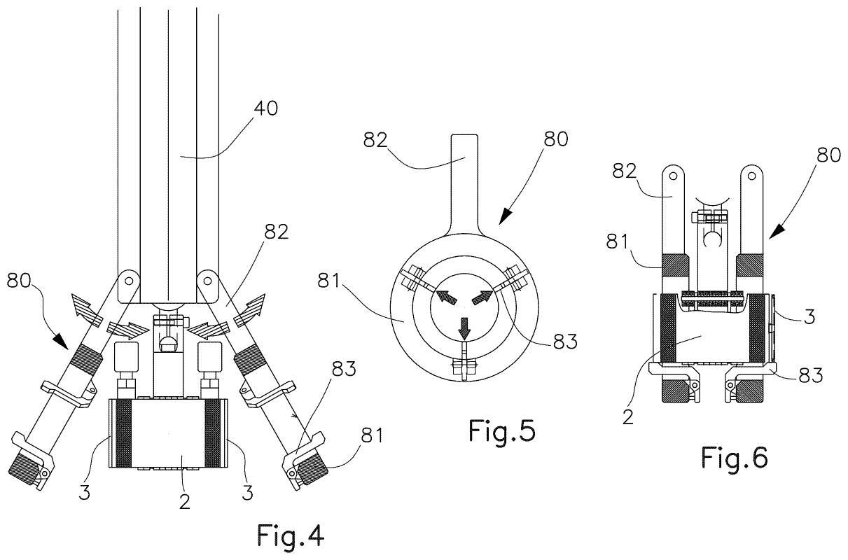

In particular, said alignment elements 80 are constituted respectively by an annular member 81 mounted at the end of an arm 82 carried in a tilting manner by the rotatable member 4 (see FIGS. 3 and 4). Each annular member 81 is internally provided with a plurality of centering members 83 configured to engage a respective metal disk of each of said pair of metal disks 3, so as to perform the precise centering of said cylindrical winding 2 and said pair of metal disks 3, when they are in the working position.

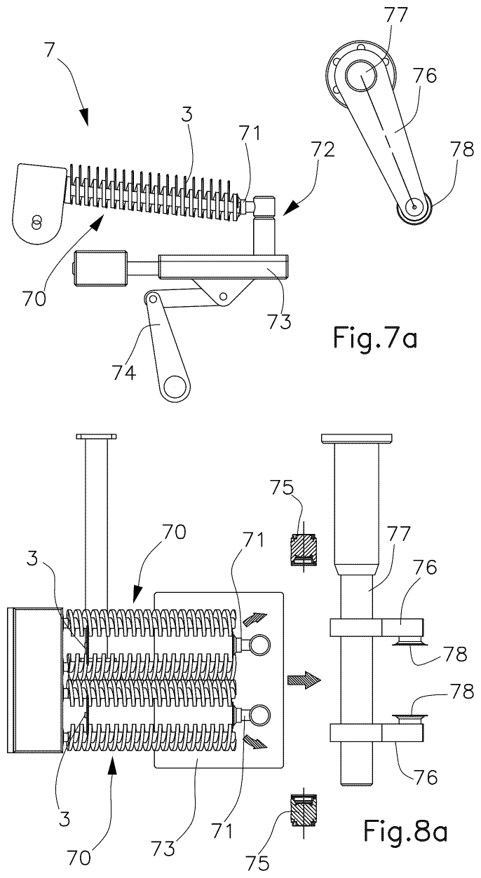

There are, for example, three of said centering members 83, spaced 120° apart from one another (FIG. 5). The centering members 83 engage a respective metal disk to perform the precise centering of said cylindrical winding 2 and said pair of metal disks 3, when they are in the working position.

The rotatable member 4 is adapted to bring in succession the cylindrical windings 2 through a series of operative stations in which the feeding and centering of the metal disks 3, the control of the positioning of said metal disks 3 and the welding of the same disks to the terminals of the electrodes protruding at the opposite ends of the cylindrical windings 2 is performed. In the shown case, the apparatus includes eight operating stations but it is of course possible to provide a number of different operating stations depending on the specific needs.

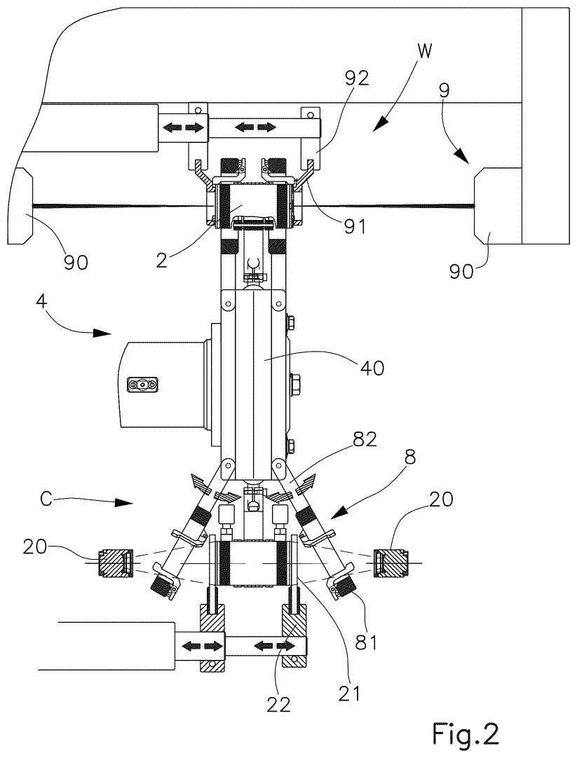

In particular, each cylindrical winding 2, after being transferred onto the rotatable member 4, passes through a first control station C where the same cylindrical winding 2 is inspected before the positioning of the metal disks 3. This first check is carried out by means of a pair of cameras 20 arranged coaxially to the axis of the cylindrical winding 2 to be inspected (FIG. 2).

Suitably, in this step the cylindrical winding 2 is clamped between a pair of contrasting elements 21 of transparent material. The contrast elements 21 are adapted to be driven in an axial direction to the cylindrical winding 2 so as to adhere to the lateral surfaces of the latter, to ensure the same focal length at both cameras 20. For this purpose the contrast elements 21 are carried by respective translating members 22 movable coaxially on command of suitably controlled motor members (see FIG. 2).

After the application of the metal disks 3 at the opposite ends, the cylindrical windings 2 pass through a second control station C′ in which each cylindrical winding 2 is further inspected, by means of a further pair of cameras arranged coaxially, before passing into the station W of welding of the metal disks 3.

The welding of the metal disks 3 to the terminals of the cylindrical winding 2 is performed, in a manner known per se, by suitable welding means 9 (FIG. 2). Said welding means 9 advantageously comprises a pair of laser sources 90 arranged coaxially to the axis of the cylindrical winding 2. In the illustrated case, the welding of the metal disks 3 is performed in a single welding station.

Suitably, in this step the cylindrical winding 2 is clamped between a further pair of contrast elements 91 adapted to be driven in the direction axial to the cylindrical winding 2 so as to adhere to the lateral surfaces of the latter. For this purpose the further contrast elements 91 are carried by respective translating members 92 movable coaxially on command of suitably controlled motor members.

Finally, the cylindrical windings 2 bearing the metal disks 3 welded at the ends, are brought by the rotatable member 4 at an outlet station O, where the cylindrical windings 2 are unloaded onto a belt conveyor 100 starting the subsequent packaging steps.

The operation of the apparatus for forming cylindrical electric batteries is easily understood from the foregoing description.

The cylindrical windings 2, fed by the conveyor belt 50, are transferred one after the other from the lifting member 61 to the rotatable member 4. The cylindrical windings 2 are gripped and retained between the grippers 42 of the gripping members 41 driven in rotation by the rotatable member 4. In this step, the shaped jaws 43 of the pliers 42 operate the first centering of the cylindrical winding 2 (FIG. 3).

In suitable phase relationship, the metal disks 3 intended to be applied to the opposite ends of the cylindrical windings 2 to make contact with the terminals of the anode and cathode elements of said cylindrical windings 2 are fed in pairs to the rotatable member 4. In particular, the metal disks 3 are fed in pairs from the screw conveyors 70 to the collecting device 72 and transferred to the suction cup gripping members 71 carried by the carriage 73 (FIGS. 7a, 8a). The carriage 73 then advances to transfer the pair of metal disks 3 collected at the pair of positioning levers 76. During this step, the suction cup gripping members 71 rotate towards the outside of the carriage 73 in a control position, at which the metal disks 3 pass in front of respective video cameras 75, which control their correct orientation (FIGS. 7b, 8b).

The metal disks 3 are then transferred to the positioning levers 76, mounted tilting about an axis parallel to the axis of the rotatable member 4 between a collection position of the said metal disks 3 from the suction cup gripping members 71 of the collection device 72 to a release position on the rotatable member (FIGS. 7c, 8c). Suitably, during this transfer step, the suction cup gripping members 78 of the positioning levers 76 are actuated in axial rotation to possibly correct the angular position of the metal disks 3.

While the positioning levers 76 transfer the metal disks 3, the collection device 72 performs the return stroke to collect a subsequent pair of metal disks 3 (FIGS. 7d, 8d).

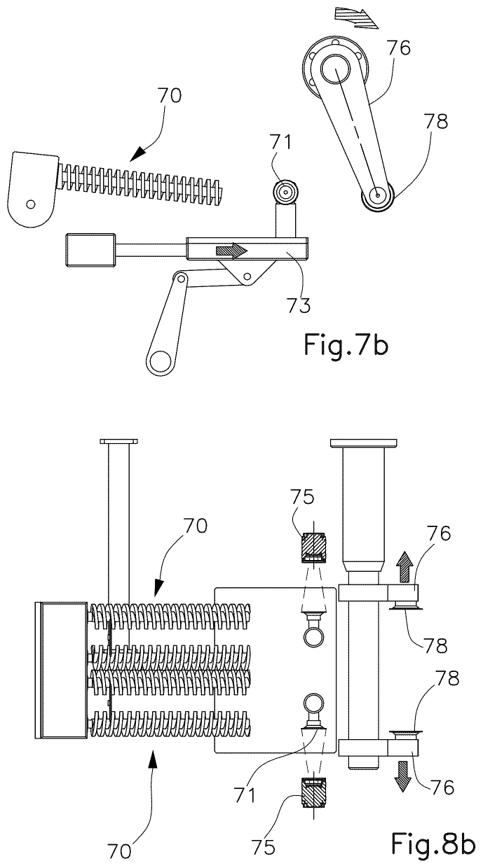

The transferred metal disks 3 are arranged at the ends of a respective cylindrical winding 2 and then hit by the annular members 81 of the alignment elements 80 carried tilting by the rotatable member 4 (FIG. 4). In such a configuration, the centering members 83 associated with the annular members 81 engage a respective metal disk of each of said pair of metal disks 3, so as to perform the precise centering of said cylindrical winding 2 and said pair of metal disks 3 (see FIGS. 5 and 6).

In a suitable phase relation, at the first and second control station C, C′, the apparatus carries out the inspection of the cylindrical windings 2 brought into rotation by the rotatable member 4 by means of suitable pairs of cameras 75 coaxially arranged (FIG. 2). Conveniently, during this step, the cylindrical winding 2 is clamped between a pair of contrast elements 21 of transparent material.

The cylindrical windings 2 are then brought to the station W of welding of the metal disks 3, where they are clamped between the contrast elements 91, operated in the axial direction so as to adhere to the lateral surfaces of the cylindrical winding 2. The welding of the metal disks 3 is performed by the pair of laser sources 90 arranged coaxial to the axis of the cylindrical winding 2.

Lastly, the cylindrical windings 2 bearing the metal disks 3 welded to the ends are brought by the rotatable member 4 to the output station O, where the same cylindrical windings 2 are collected by the rotatable member 4 to be unloaded onto the belt conveyor 100 and sent to the subsequent steps of packaging.

The described apparatus achieves the object of optimally forming electric energy storage devices, such as cylindrical electric batteries comprising a cylindrical winding formed by at least one anode element, a cathode element and a separator interposed between said anode and cathode elements, and carrying a pair of metal covering disks applied to the opposite ends.

In particular, the apparatus for forming electric energy storage devices according to the present invention enables a perfect centering of the metal closing disks of the ends of the cylindrical winding.

A feature of the present invention is the fact that the apparatus carries out the simultaneous application of the pair of metal disks for closing the opposite ends of the cylindrical winding, ensuring the perfect centering of both said metal disks.

The apparatus described by way of example is susceptible to numerous modifications and variations according to the different requirements.

In the practical embodiment of the invention, the materials used, as well as the shape and the dimensions, may be modified depending on needs.

Should the technical features mentioned in any claim be followed by reference signs, such reference signs were included strictly with the aim of enhancing the understanding of the claims and hence they shall not be deemed restrictive in any manner whatsoever on the scope of each element identified for exemplifying purposes by such reference signs.

1. An apparatus for forming devices for storing electrical energy, of the type comprising a cylindrical winding formed by at least one anode element, a cathode element and a separator interposed between said anode and cathode elements, and having a pair of metal disks applied at the opposite ends thereof, adapted to make contact with the terminals of said anode and cathode elements, said apparatus comprising:
a rotatable member for carrying said cylindrical windings in succession by means of gripping members at a series of operative stations;
first feeding means adapted to feed said cylindrical windings in an ordered sequence;
means for transferring said cylindrical windings to said rotatable member;
second feeding means adapted to feed to said rotatable member of said pairs of metal disks;
means for centering said metal disks and said respective cylindrical windings respectively configured to simultaneously align the disks of each of said pair of metal disks with said terminals of the respective cylindrical winding and to position the axis of the cylindrical winding in a predefined position;
means for welding said pairs of metal disks configured to simultaneously weld each pair of metal disks to the respective terminals of said anode and cathode elements of the cylindrical windings.

2. The apparatus of claim 1, wherein each of said gripping members comprises a pair of pliers pivoted according to axes parallel to the axis of rotation of said rotatable member and operable in angular rotation between a reciprocal open position and a closed position in which the same pliers are capable of retaining a relative cylindrical winding.

3. The apparatus of claim 2, wherein said means of centering said cylindrical windings comprises shaped jaws mounted at the ends of said pliers and suitable for centering said cylindrical winding.

4. The apparatus of claim 3, wherein each shaped jaw comprises an element pivoted on the respective pliers and has a circumferential arc profile.

5. The apparatus of claim 1, wherein said second feeding means comprises conveyor means adapted to feed said pairs of metal disks in sequence, and a device for collecting a pair of said pairs of metal disks, movable with reciprocating motion in a substantially radial direction to said rotatable member and carrying a pair of gripping members adapted to receive said pair of metal disks from said conveyor means.

6. The apparatus of claim 5, wherein said conveyor means comprises a pair of screw conveyors configured to advance the pairs of metal disks towards said collection device.

7. The apparatus of claim 5, wherein said second feeding means further comprises a pair of positioning levers equipped, in opposite positions, with further gripping members adapted to receive said pair of metal disks from said collection device and to transfer it to the means of centering said metal disks.

8. The apparatus of claim 7, wherein said further gripping members are operable in axial rotation, according to an axis parallel to the axis of rotation of said rotatable member, by means of drive members configured to adjust the angular position of said pair of metal disks.

9. The apparatus of claim 1, wherein said means of centering said metal disks comprises a pair of alignment elements arranged at each gripping member of said rotatable member and carried tiltably by the same rotatable member, said alignment elements being movable between a disengagement position, in which they are spread apart from each other, and a working position in which they perform a centering of said pair of metal disks on the respective cylindrical winding.

10. The apparatus of claim 9, wherein said alignment elements are constituted respectively by an annular member mounted at the end of an arm carried in a tilting manner by said rotatable member, each annular member being internally provided with a plurality of centering members configured to engage a respective metal disk of each of said pair of metal disks, so as to perform a precise centering of said cylindrical winding and said pair of metal disks, when they are in the working position.

11. The apparatus of claim 1, further comprising at least one control station (C) comprising a pair of video cameras arranged coaxially to the axis of the cylindrical winding carried by the rotatable member and a pair of contrast elements operable in the axial direction of the same cylindrical winding so as to adhere to the lateral surfaces of said cylindrical winding, to ensure the same focal distance at both said cameras.

12. A method for forming electric energy storage devices, of the type comprising a cylindrical winding formed by at least one anode element, a cathode element and a separator interposed between said anode and cathode elements, and having a pair of metal disks, applied at the opposite ends thereof, suitable for making contact with the terminals of said anode and cathode elements respectively, further comprising the steps of:
a. feeding, in an ordered sequence, a series of said cylindrical windings;
b. orderly transferring said cylindrical windings to a rotatable member adapted to bring the same cylindrical windings in succession to a series of operative stations;
c. feeding, in a suitable phase relationship, said pairs of metal disks to said rotatable member;
d. associating said pairs of metal disks with controlled pressure to the opposite ends of said cylindrical windings;
e. centering said metal disks on said respective cylindrical windings;
f. performing the simultaneous welding of the metal disks of each of said pairs of metal disks to said terminals of said anode and cathode elements of the cylindrical windings.

13. The method of claim 12, wherein it comprises the further comprising the step of b1. controlling the correct alignment of the same cylindrical winding in at least one control station (C) arranged in one of said series of operative stations, by means of a pair of video cameras arranged coaxially to the axis of the cylindrical winding to be inspected.

14. The method of claim 12, wherein said step d. is carried out by simultaneously bringing a pair of each of said pairs of metal disks to the respective cylindrical winding.
